(19) United States
(12) Patent Application Publication
(10) Pub. No.: US 2024/0035328 A1
(43) Pub. Date: Feb. 1, 2024

(54) DISPLAY CASE DOOR WITH TOUCHLESS OPENING

(71) Applicant: Anthony, Inc., Sylmar, CA (US)

(72) Inventor: Adrian Rodriguez, Santa Clarita, CA (US)

(21) Appl. No.: 17/815,422

(22) Filed: Jul. 27, 2022

(51) Int. Cl. E05F 15/614; E05F 15/40; E05F 15/71; E05F 15/73; E05F 1/10; A47F 3/04

(52) U.S. Cl. CPC E05F 15/614; E05F 15/40; E05F 15/71; E05F 15/73; E05F 1/1033; A47F 3/043; E05F 2015/763; E05Y 2201/434; E05Y 2201/486; E05Y 2201/716; E05Y 2400/40; E05Y 2400/44; E05Y 2400/45; E05Y 2400/532; E05Y 2400/54; E05Y 2400/86; E05Y 2900/31

(57) ABSTRACT

A display case door includes a door frame, a motor, and a torque rod. The door frame extends about and is coupled to a panel assembly. The motor is coupled to the door frame. The torque rod is coupled to the door frame and configured to couple with an enclosure for a display case. When the door is installed in an opening of the enclosure for the display case, the motor is operable to open the display case door, and the torque rod is configured to close the display case door.

### TECHNICAL FIELD

The present disclosure relates to thermally insulated doors for temperature-controlled enclosures.

### BACKGROUND

Refrigerated enclosures are used in commercial, institutional, and residential applications for storing and/or displaying refrigerated or frozen objects. Refrigerated enclosures may be maintained at temperatures above freezing (e.g., a refrigerator) or at temperatures below freezing (e.g., a freezer). Refrigerated enclosures have one or more thermally insulated doors for accessing refrigerated or frozen objects within a temperature-controlled space. Doors for refrigerated enclosures generally include thermally insulated panel assemblies. Some doors include glass panel assemblies that permit customers to view products within the refrigerated enclosures. Some doors include video screens that display a representation of products contained within the refrigerated enclosures.

Display case doors are typically opened manually. All users of the display case grip the same handle. For refrigerated enclosures with many users (e.g., in public places such as supermarkets), there can be a significant risk of transfer of surface-borne pathogens from user to user.

### SUMMARY

The present disclosure relates to systems and methods for opening and closing a doors of temperature-controlled enclosures.

In a general aspect of the present disclosure, a display case door includes a door frame, a motor, and a torque rod. The door frame extends about and is coupled to a panel assembly. The motor is coupled to the door frame. The torque rod is coupled to the door frame and configured to couple with an enclosure for a display case. When the door is installed in an opening of the enclosure for the display case, the motor is operable to open the display case door, and the torque rod is configured to close the display case door.

In some implementations, the display case door further includes a hinge. The motor is coupled to the hinge.

In some implementations, the motor is coupled to a portion of the torque rod.

In some implementations, the motor is configured to rotate a portion of the door frame relative to the portion of the torque rod such that the door swings out.

In some implementations, the motor is configured to couple between the enclosure and the door frame. When the motor is coupled between enclosure and the door frame, the motor is operable to open the display case door.

In some implementations, the motor is configured to couple between the enclosure and a portion of the torque rod.

In some implementations, the motor is configured to rotate a first portion of the torque rod relative to a second portion of the torque rod.

In some implementations, the display case door includes a motor controller configured to control the motor to swing the display case door such that the display case door opens.

In some implementations, the motor is operable to close the display case door.

In some implementations, the display case door includes a motor controller. The motor controller is configured to control the motor to swing the display case door such that the display case door shuts.

In some implementations, the display case door includes a hold open device including a detent. The hold open device is configured to hold the display case door open at a pre-determined angle. The motor is operable to overcome a force of the detent such that the torque rod closes the display case door.

In some implementations, the display case door includes a motor controller configured to determine whether a condition for opening the door has been met; and control the motor to open the display case door based on determining that the condition has been met.

In some implementations, the display case door includes a motor controller configured to open the door in response to a command from a user, and a user control coupled to the motor controller.

In some implementations, the display case door includes a motor controller configured to, in response to receive a signal, determine whether a trigger condition for opening the door has been met.

In some implementations, the display case door includes one or more sensors coupled to the motor controller, the motor controller is configured to open the door in response to receiving a signal from at least one of one or more sensors.

In some implementations, at least one of the one or more sensors is a motion sensor.

In some implementations, at least one of the one or more sensors is a gesture recognition sensor.

In some implementations, at least one of the one or more sensors is a presence sensor.

In some implementations, the display case door includes one or more sensors coupled to the motor controller. The motor controller is configured to close the display case door in response to receiving a signal from the sensor.

In some implementations, at least one of the one or more sensors is a temperature sensor.

In some implementations, the display case door includes one or more sensors coupled to the motor controller, the motor controller is configured to stop closing the display case door in response to receiving a signal from the sensor.

In some implementations, the display case door includes a sensor configured to detect whether there is an obstruction to closing the door, the motor controller is configured to inhibit operation of the motor in response to receiving a signal from the sensor.

In another general aspect of the present disclosure, a display case door includes an insulated panel assembly including one or more panes, a door frame, and a motor assembly. The door frame extends about and is coupled to the insulated panel assembly. The door frame includes a hinge-side rail; and a motor assembly coupled to the hinge-side rail. The motor assembly includes a motor and one or more drive members. When the door installed is in an opening of an enclosure for a display case, the motor is operable to open the display case door.

In some implementations, at least one of the one or more drive members is at least partially enclosed in the hinge-side rail.

In another general aspect of the present disclosure, a system for opening a display case door includes a door opening mechanism that is configured to be coupled to a hinge-side frame of a display case door and exert an opening force against a hinge device of the display case door. The door opening mechanism includes a motor coupled to an output gear and a motor controller electrically coupled to the motor. The output gear is arranged to engage with corresponding portion of the door hinge device. The motor controller is operable to control the motor to open the display case door.

In some implementations, the system for opening a display case door the hinge device includes a torque rod.

In some implementations, the system for opening a display case door the hinge device includes a torque adjustment mechanism.

Particular implementations of the subject matter described in this specification can be implemented so as to realize one or more of the following advantages.

Implementations of the present disclosure may allow for touchless operation of the door of a display case.

Implementations of the present disclosure may mitigate a risk of transfer of surface-borne pathogens among users of a refrigerated enclosure.

Implementations of the present disclosure may make allow for display cases to be opened without requiring a user to exert a manual force on a door handle.

Implementations of the present disclosure may reduce energy loss and maintenance costs due to doors of refrigerated enclosures being left open inadvertently or not being fully closed by a user/customer.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIGS. 1-2 show an exemplary refrigerated enclosure according to some implementations of the present disclosure.

FIG. 3 is a perspective view of a display case door having a door opening mechanism according to implementations of the present disclosure.

FIG. 4 is a front view of a refrigerated enclosure included a torque rod and an automatic opening mechanism.

FIG. 5 is an example of a door opening mechanism coupled to a torque rod on a display case door.

FIG. 6 is a cross sectional view of the door opening mechanism shown in FIG. 5, taken along lines 6-6.

FIGS. 7A and 7B illustrate operation of a motorized door opening mechanism.

FIG. 8 illustrates a system having a door opening mechanism coupled between sections of a torque rod.

FIG. 9 illustrates a system in which a motor rotates an upper portion of a torque rod to open a display case door.

### DETAILED DESCRIPTION

In some implementations, a door opening mechanism provides touchless opening of the door of a display case. Particular implementations include a motorized mechanism for opening or closing a display case door in response to a user operation or to sensor input.

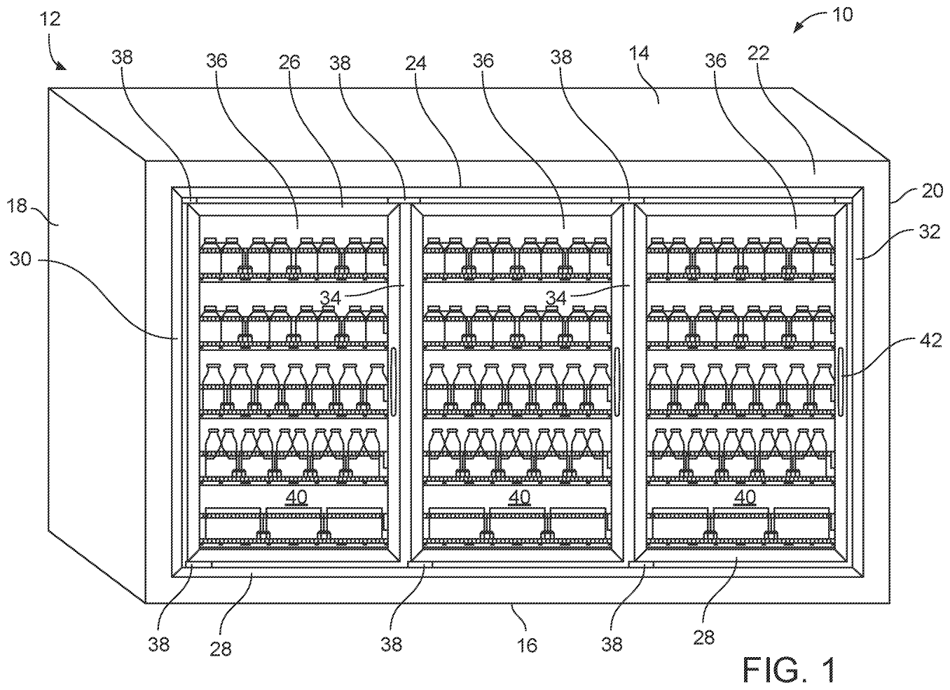

FIGS. 1-2 show an exemplary refrigerated enclosure 10. Refrigerated enclosure 10 may be a refrigerator, freezer, or other enclosure defining a temperature-controlled space. In some implementations, refrigerated enclosure 10 is a refrigerated display case. For example, refrigerated enclosure 10 may be a refrigerated display case or refrigerated merchandiser in grocery stores, supermarkets, convenience stores, florist shops, and/or other commercial settings to store and display temperature-sensitive consumer goods (e.g., food products and the like). Refrigerated enclosure 10 can be used to display products that must be stored at relatively low temperatures and can include shelves, glass doors, glass walls, and/or video displays to permit viewing of the products supported by the shelves. In some implementations, refrigerated enclosure 10 is a refrigerated storage unit used, for example, in warehouses, restaurants, and lounges. Refrigerated enclosure 10 can be a free standing unit or “built in” unit that forms a part of the building in which refrigerated enclosure 10 is located.

Refrigerated enclosure 10 includes a body 12. Body 12 includes a top wall 14, a bottom wall 16, a left side wall 18, a right side wall 20, a rear wall (not shown), and a front portion 22 defining a temperature-controlled space. Front portion 22 includes an opening into the temperature-controlled space. Thermal frame 24 is can be mounted at least partially within the opening. Thermal frame 24 includes a plurality of perimeter frame segments (i.e., a header or top frame segment 26, a sill or bottom frame segment 28, a left side frame segment 30, and a right side frame segment 32) forming a closed shape along a perimeter of the opening. In some implementations, thermal frame 24 includes one or more mullion frame segments 34 dividing the opening into multiple smaller openings. For example, FIG. 1 illustrates a three-door assembly with a pair of mullion frame segments 34 extending between top frame segment 26 and bottom frame segment 28 to divide the opening into three smaller openings. Each of the smaller openings may correspond to a separate display case door 36 of the three-door assembly. In other implementations, mullion frame segments 34 may be omitted. For example, FIG. 2 illustrates a one-door assembly wherein thermal frame 24 includes perimeter frame segments 26-32 but not mullion frame segments 34. In some implementations, thermal frame 24 includes include top frame segment 26 and bottom frame segment 28 with no side frame segments 30 or 32. In such implementations, thermal frame 24 may include one or more mullion frame segments (e.g., such as mullion 34 frame segment 34 shown in FIG. 1) depending, for example, on the size of the refrigerated enclosure in which thermal frame 24 is to be installed and the number of doors.

Refrigerated enclosure 10 includes one or more display case doors 36 pivotally mounted on the thermal frame 24 by hinges 38. In some implementations, the display case doors 36 are sliding doors configured to open and close by sliding relative to the thermal frame 24. The example display case doors 36 illustrated in FIGS. 1 and 2 include panel assemblies 40 and handles 42. Referring to FIG. 2, thermal frame 24 is includes a series of contact plates 44. Contact plates 44 are attached to a front surface of thermal frame 24 and provide a sealing surface against which display case doors 36 rest in the closed position. For example, doors 36 may include a gasket or other sealing feature around a perimeter of each display case door 36. The gaskets may employ a flexible bellows and magnet arrangement, which, when the display case doors 36 are closed, engage contact plates 44 to provide a seal between doors 36 and thermal frame 24. The thermal frames provide a thermally conductive path from the frame segments 26-32, for maintaining maintains the temperature of the contact plates 44 at or close to the temperature of the external environment (e.g., the environment outside of the refrigerated enclosure 10) and to aid in preventing condensation from forming on the contact plates 44. Preventing condensation on the contact plates may provide for a more positive seal between the contact plates 44 and a magnetic gasket on the door, thereby improving the thermal properties of the refrigerated enclosure 10.

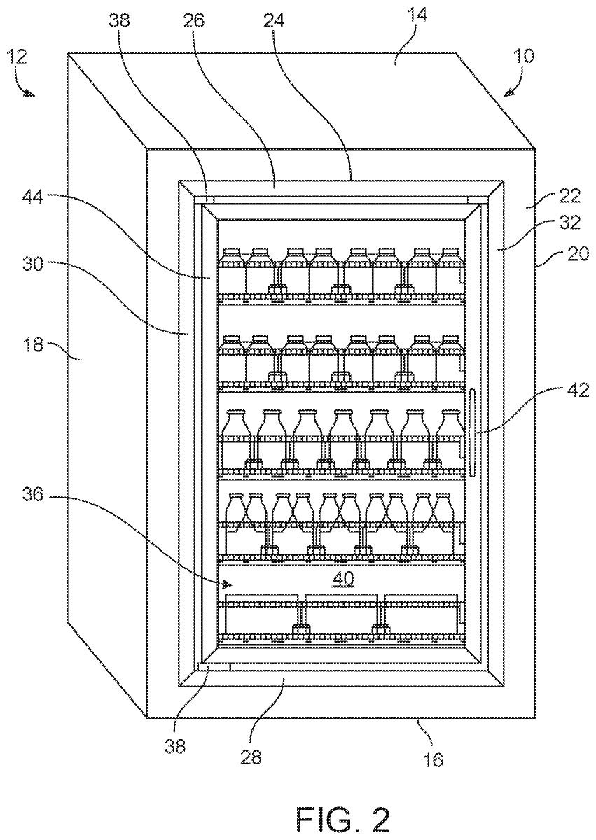

FIG. 3 is a perspective view of a display case door 50 having a door opening mechanism according to implementations of the present disclosure. Display case door 50 can be installed in a refrigerated display case such as a refrigerator, a freezer, or other enclosure defining a temperature-controlled space.

Door assembly 54 includes door frame 56. Door frame 56 includes hinge-side rail 58, handle-side rail 60, top rail 62, and a bottom rail (not shown in FIG. 3).

In some implementations, display case door 50 includes an electronic display assembly 52 mounted on door assembly 54. Electronic display assembly 52 can be mounted in front of an insulated panel assembly (e.g., a glass insulated panel assembly or an opaque foam panel assembly) in a door frame 56 secured to an edge of the insulated panel assembly. The electronic display assembly 52 can include, e.g., a video display in electronic communication with control circuitry configured to display video and/or images including, but not limited to, images of products contained in a display case, advertisements, nutritional information, etc.

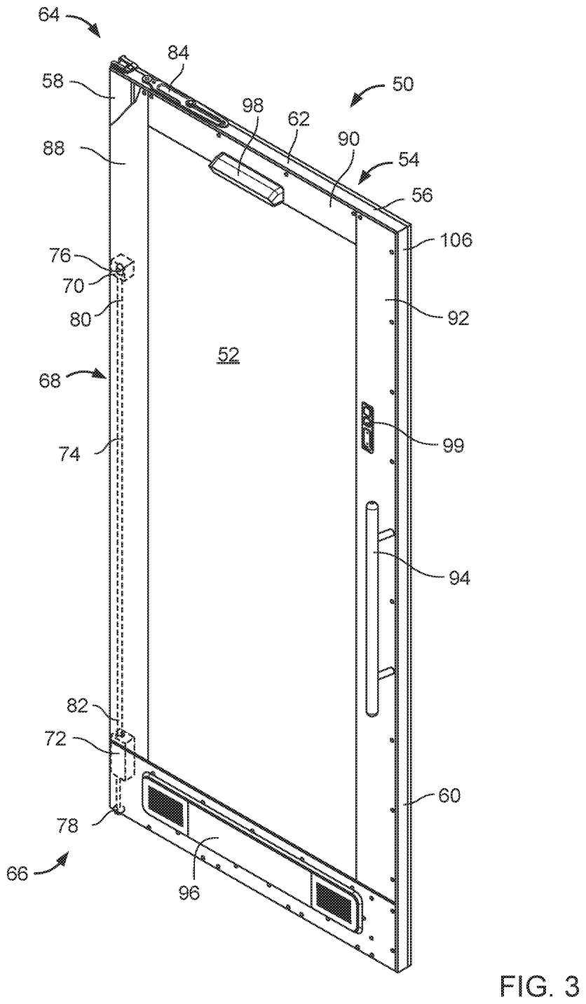

Display case door 50 can be installed in an enclosure on upper hinge 64 and lower hinge 66. Display case door 50 includes torque rod assembly 68, torque rod upper anchor device 70, and door opening mechanism 72. Torque rod assembly 68 includes torque rod 74, torque rod cap 76, and lower hinge pin 78. Torque rod upper anchor device 70 secures the upper end 80 of torque rod 74 to hinge-side rail 58. The lower end 82 of torque rod assembly is secured to hinge pin 78. Hinge pin 78 can be coupled to an anchor member on the enclosure in which display case door 50 is installed (as shown in FIG. 4). Door opening mechanism 72 can include a motor that operates to open and close display case door 50.

Hold-open bracket 84 is provided on a top edge of display case door 50. Hold-open bracket 84 is coupled to door frame 56. When installed in the enclosure, hold-open bracket 84 can be used to maintain display case door 50 in a desired open position.

Electronic display assembly 52 is mounted in door frame 56, with bezels installed around the edges of door frame 56. Display case door 50 includes left bezel 88, top bezel 90, and right bezel 92.

Display case door 50 includes handle 94. Electronic display assembly 52 includes circuitry module 96, top sensor 98, and handle-side sensor 99. The outside edges of circuitry module 96 are secured to hinge-side rail 58 and handle-side rail 60 of door frame 56. Left bezel 88 and right bezel 92 can be attached to their respective rails.

FIG. 4 is a front view of a refrigerated enclosure included a torque rod and automatic opening mechanism. Display case door 50 is installed in an opening of enclosure 10.

Door frame 56 extends around and is secured to a peripheral edge of insulated panel assembly 100. Door frame 56 defines a channel or tunnel that receives one or more power cables that provide electrical power to the electronic display assembly. The channel can also enclose all or a portion of door opening mechanism 72.

Insulated panel assembly 100 can include one or more panes of glass. In some implementations, insulated panel assembly 100 includes two or more layers of transparent panes bounding a sealed space in between, forming a sealed glass unit (SGU).

In some implementations, the gap or sealed space between two or more panels can be filled with an insulating gas such as a noble gas (e.g., argon, krypton, etc.) which functions as a thermal insulator to reduce heat transfer through the panel. In some examples, the sealed space can be evacuated below atmospheric pressure.

Upper hinge 64 and the lower hinge 66 together define the pivot axis 102 of display case door 50, about which display case door 50 swings. In this example, upper hinge pin 104 is fixedly secured to the display case door 50 and protrudes upwardly. Upper hinge pin 104 is received by a hinge pin socket 106 disposed and fixed in the top horizontal frame member of the enclosure 10. In some implementations, upper hinge pin 104 is retractable. Lower hinge pin 78 of torque rod assembly 74 is received in anchor device 108.

At least a portion of the upper end 80 of the torque rod 74 can have a non-circular shape (for example, a key shape), which can be matingly received and secured in a mating aperture (for example, a corresponding key hole) in the torque rod upper anchor device 70. This secure attachment prevents relative rotation between the upper end 80 of the torque rod 74 and display case door 50. The torque rod assembly 68 serves to provide a biasing force which is used to close the display case door 50 when the display case door is released in the open position, and to bias display case door 50 to maintain the door in a closed position.

In some implementations, anchor device 108 includes a mechanism for adjusting the biasing torque on torque rod 74. The adjustment mechanism can include, for example, a manual adjustment screw.

Door opening mechanism 72 is coupled to hinge-side rail 58 of door frame 56. Door opening mechanism 72 can be operated to rotate on lower portion 82 of torque rod 74 such that display case door 50 swings outwardly with respect to enclosure 10. As display case door 50 swings outward, hinge-side rail 58 also swings outward, along with torque rod upper anchor device 70 and upper portion 80 of torque rod 74. With display case door 50 in an open position, torque rod 74 is biased to close display case door 50.

A motor in door opening mechanism 72 can be operated to swing display case door 50 to a desired angle relative to enclosure 10. The motor can be any motor device that enables position control, such as a stepper motor or servo motor.

Display case door 50 includes sensor 114. Sensor 114 can be coupled to door opening mechanism 72. Sensor 114 can provide signals to door opening mechanism 72. The signals can be used by door opening mechanism 72 to control operation of door opening mechanism 72 to open and close display case door 50.

In some implementations, electric power is provided through the upper hinge pin 104 of display case door 50. Electrical conductors (e.g., wire harnesses) can be routed inside door frame 56 to supply power to an electronic display assembly of display case door 50, heater wires, door opening mechanism 72, and sensors 114.

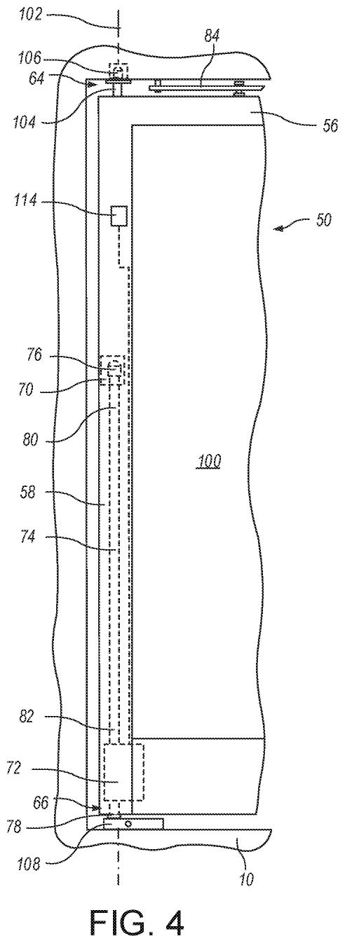

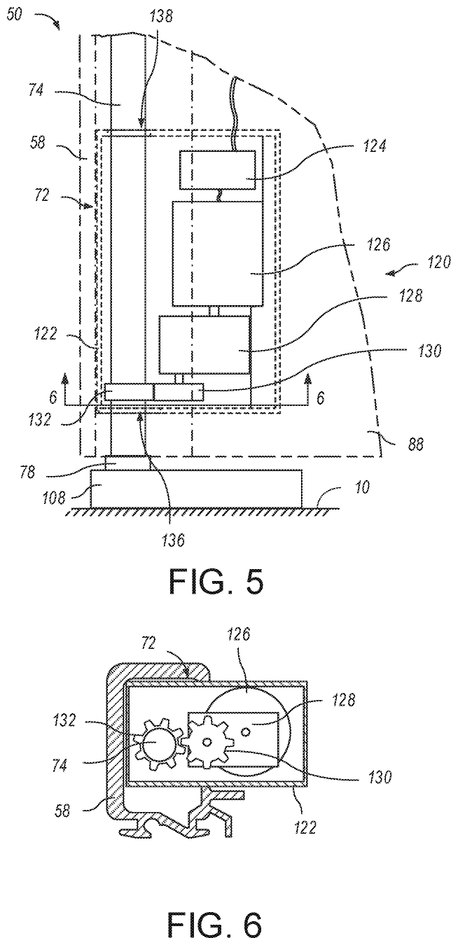

FIG. 5 is an example of a door opening mechanism coupled to a torque rod on a display case door. FIG. 6 is a cross sectional view of the door opening mechanism shown in FIG. 5, taken along lines 6-6. Door opening mechanism 72 includes a motor assembly 120, housing 122, and motor controller 124. Motor assembly 120 and motor controller 124 are enclosed in housing 122. Housing 122 is secured on hinge-side rail 58. As is shown in FIG. 4, the axis of torque rod 74 is aligned with lower hinge pin 78.

Motor assembly 120 includes motor 126, gearbox 128, and output gear 130. Torque rod gear 132 is fixed on torque rod 74. Torque rod 74 passes through lower opening 136 and upper opening 138 of housing 122. Motor assembly 120 can be operated to rotate door opening mechanism 72 to swing hinge-side rail 58 with respect to lower hinge pin 78, such that display case door 50 opens on enclosure 10.

Motor controller 124 can be operated to control motor 126 to rotate housing 122 a predetermined angle with respect to torque rod 74. Motor 124 can be a stepper motor, servo motor, or other type of motor. In certain implementations, door opening mechanism includes a clutch device that limits opening of display case door 50 to a desired angle.

In the example shown in FIGS. 5 and 6, the opening mechanism includes a rotary motor. Other types of devices to move the door can be used in various implementations. In some implementations, a door opening mechanism includes one or more linear motion devices, such as a linear actuator.

In some implementations, a motor for a door opening/closing mechanism is included in, or coupled to a hinge device for the display case door. The motor can include a driver member (e.g., output gear) that drives a linkage, gear coupling, or other mechanism of the hinge to swing the display case door to open or close the door. In one implementation, a hinge includes a drive member on the door side (e.g., a gear or spline) that engages and drives a corresponding member on the enclosure-side to open or close the display case door. In one example, a drive member at the base of the display case door couples with a corresponding member attached to the door frame (e.g., in the location of anchor device 108 shown in FIG. 4). In certain implementations, the hinge device used to open or close the door is included a torque rod assembly for the door.

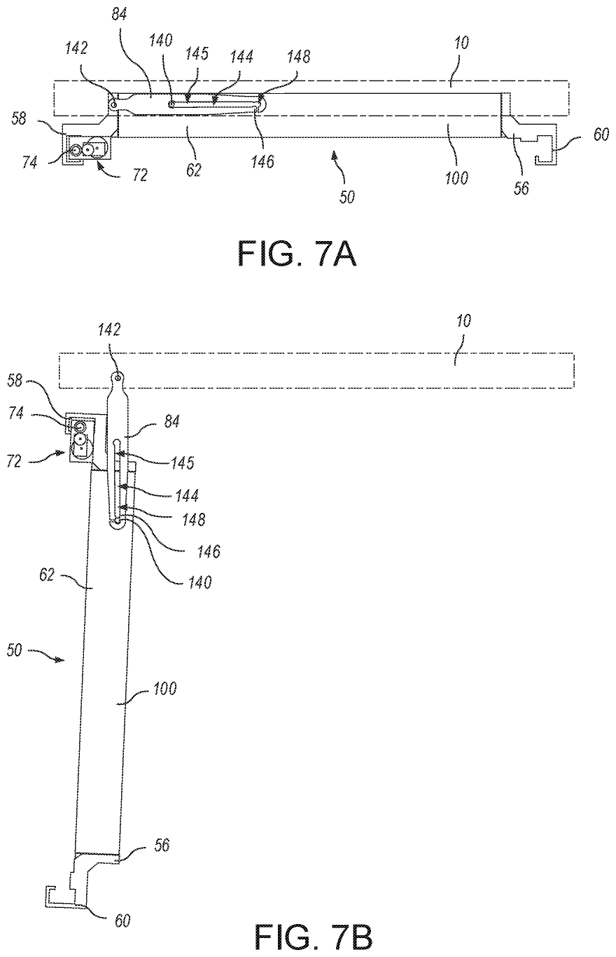

FIGS. 7A and 7B illustrate operation of a motorized door opening mechanism. In FIG. 7A, display case door 50 is closed on enclosure 10. Display case door 50 includes insulated panel assembly 100, door frame 56, torque rod 74, and door opening mechanism 72. Door frame 56 includes hinge-side rail 58, handle-side rail 60, and top rail 62, and hold-open bolt 140. Hold-open bolt 140 is attached to top rail 62 of door frame 56. Pivot pin 142 is attached to enclosure 10.

Hold-open bracket 84 is pivotally coupled to pivot pin 142. Hold-open bracket 84 includes slot 144. Slot 144 includes a detent 146 near the distal end 148 of slot 144. With display case door 50 closed on enclosure 10, hold-open bolt 140 is at proximal end 145 of slot 144.

Motor 126 (e.g., as shown in FIGS. 5 and 6) of door opening mechanism 72 can be operated to rotate door opening mechanism 72 relative to torque rod 74. Motor 126 can continue to operate until display case door 50 reaches fully open position shown in FIG. 7B. In FIG. 7B, hold-open bolt 84 has traveled to distal end 148 of slot 144. Motor 126 can be switched off once display case door 50 reaches the full open position.

In this example, detent 146 is in the form of a pair of opposing protrusions along slot 144. To pass between the opposing protrusions in either direction, an external force must be applied to overcome the spring force of the opposing side arms of hold-open bracket 84. Detent 146 may maintain display case door 50 in an open position until a force is applied to display case door 50 sufficient to overcome holding force of the detent.

In some implementations, motor 126 is operated to close display case door 50. In one implementation, motor 126 operates until door 50 reaches a closed position shown in FIG. 7A. In other implementations, motor 126 is operated long enough to swing display case door toward a closed position to overcome detent 146. Display case door 50 continues to swing inwardly under the force exerted by torque rod 74 until display case door 50 reaches the fully closed position shown in FIG. 7A.

In some implementations, a motorized mechanism is operable to open and close a display case door. In one implementation, the motor of a door mechanism is operated to open a display case door until the door engages on a latch. The display case door can remain in the open position until the latch is released. Upon release of the latch, the motor of the door mechanism is operated to close the door. In one implementation, the latch is released automatically by a controller (e.g., based on sensor input or a trigger condition such as a time limit for the door being open). In some implementations, the latch is released manually.

In various implementations, door opening mechanism 72 is activated in response to a signal from one or more sensors (such as sensor 114 shown in FIG. 4). A sensor-activated door can allow display case door to be opened in a touchless manner, without the user having to grasp a handle or any other part of the door.

In some implementations, the door mechanism operates to a display case door based on one or more trigger conditions. The trigger conditions can include actions by a user in front of the display case. In some implementations, the user can press a button to activate the motor to open the door. In certain implementation, the user activates a door opening mechanism with a remote control device or smart phone.

In some implementations, the door mechanism operates to open the door in response to the presence or action of a user. Examples of sensors that can be used include a motion sensor, a gesture-recognition sensor, a presence sensor, an audio sensor, or a light sensor. Examples of open triggers can include: waving hand, voice command, push button, and capacitive touch. In one example, the door opening mechanism operates to open the door in response to a user waving a hand over the sensor. In one implementation, the door is voice-activated by a user. For example, the door opening mechanism can open the door when a user speaks “open door” and close the door when the user speaks “close door”.

In some implementations, the door mechanism operates to close the door based on one or more trigger conditions. Examples of trigger conditions include an action of user (for example, the user pressing button to close the door), a time-related condition (the door has been open a time exceeds a predetermined limit), or environmental conditions inside or around a display case. In one example, a door mechanism closes when the temperature in the enclosure reaches a predetermined threshold temperature.

In some implementations, a door mechanism operates to close the door in response to a signal from one or more sensors. Examples of sensors that can be used to provide a signal to close the door include a temperature sensor, a motion sensor, or a gesture-recognition sensor. In one example, a door mechanism closes in response to a temperature sensor inside the enclosure providing a signal indicating that a temperature in the enclosure exceeds a threshold temperature.

In some implementations, door mechanism automatically shuts off during operation in response to a signal from a sensor. For example, the door mechanism can include a circuit for detecting overcurrent in a motor circuit if an obstruction is encountered in the path of a display case door when the motor is being operated to open or close the door.

Door opening and closing systems and methods (such as motor controller 124 shown in FIG. 5) can be implemented in electronic circuitry, computer hardware, firmware, software, or in combinations of these elements. Devices can include input and output devices, a computer processor, and a computer program product embodied in a machine-readable storage device for execution by a programmable processor. Techniques can be performed by a programmable processor executing a program of instructions to perform desired functions by operating on input data and generating appropriate output. Techniques can be implemented in one or more computer programs that are executable on a programmable system including at least one programmable processor coupled to receive data and instructions from, and to transmit data and instructions to, a data storage system, at least one input device, and at least one output device. Suitable processors include, by way of example, both general and special purpose microprocessors. Generally, a processor will receive instructions and data from a read-only memory and/or a random access memory. Storage devices may include all forms of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM). Any of the foregoing may be supplemented by, or incorporated in, specially-designed ASICs (application-specific integrated circuits).

In some of the implementations shown herein (for example, FIGS. 5 and 6), a door opening drives against a portion of the torque rod near the bottom end of the torque rod to cause the display case door to open or close the display case door. A motor for opening or closing a display case door can, however, be provided in other locations or in different arrangements relative to a door frame and the enclosure of the display case. In some implementations, a motor for opening and closing the door is separate from the torque rod. In one implementation, a motor is included in a hinge assembly of a display case door (either at the top or bottom of the door). The motor for a door opening or closing mechanism may or may not be engaged with a torque rod.

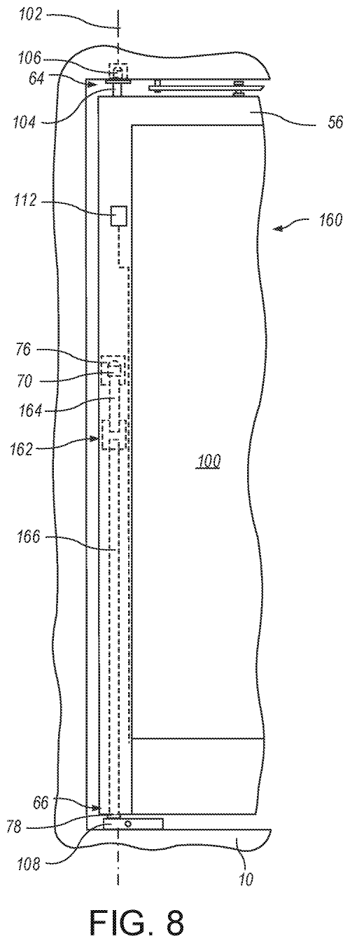

FIG. 8 illustrates a system in which the motor rotates an upper portion of a torque rod with respect to a lower portion of a torque rod so as to open a display case door. Display case door 160 includes door opening mechanism 162, torque rod upper section 164, and torque rod lower section 166. Door opening mechanism 162 is operably coupled between torque rod upper section 164 and torque rod lower section 166. Door opening mechanism 162 includes a motor operable to rotate torque rod upper section 164 relative to torque rod lower section 166. As the motor operates to rotate upper portion 80 of torque rod 162, torque rod upper section 164 and door frame 56 are swung in or out on axis 102. Control of door opening mechanism 162 can be performed in a similar manner to that described above relative to FIGS. 1 through 7B.

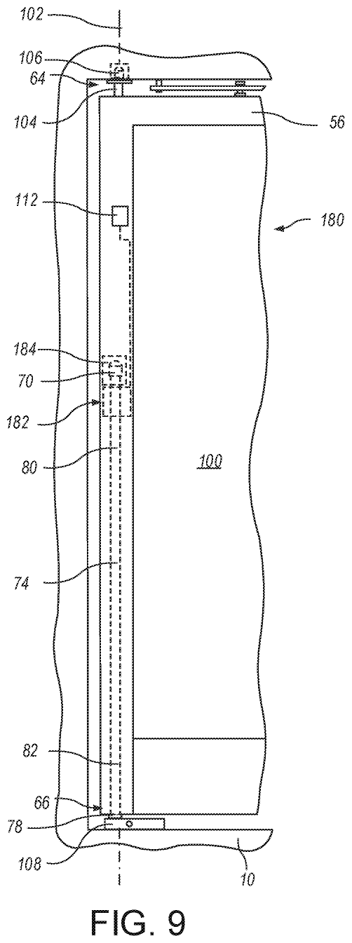

FIG. 9 illustrates a system in which the motor rotates an upper portion of a torque rod relative to an enclosure so as to open a display case door. Display case door 180 includes door opening mechanism 182, torque rod 74, and torque rod upper anchor 184. When display case door 180 is installed on enclosure 10, door opening mechanism 180 can be fixed with respect to enclosure 10 (for example, by way of a pin on the housing of door opening mechanism 182 inserted into the enclosure 10). Door opening mechanism 182 includes a motor operable to rotate upper portion 80 of torque rod 74 relative to enclosure 10 such that display case door 180 is opened and closed on enclosure 10. As the motor operates to rotate upper portion 80 of torque rod 74, torque rod upper anchor 184 and door frame 56 are swung in or out on axis 102. Control of door opening mechanism 182 can be performed in a similar manner to that described above relative to FIGS. 1 through 7B.

A torque adjustment mechanism can be adjusted to ensure that the door closes when automatic door opening mechanism is not being operated to maintain the door open. In some cases, the torque adjustment mechanism includes an adjustment screw.

In various implementations described above, a motor for an automatic opening mechanism is installed in a rail of the door. In other implementations, the motor can be mounted to the door outside the door rail. The motor for an automatic door opening mechanism can also be external to the door. The motor can be coupled to the torque rod between closing torque-adjustable anchor device and the door. As one example, an external motor and gears can be coupled with a torque rod and an anchor device mounted on the base of the door frame 56.

In certain implementations, a motor controller, user control, or both are external to the door. For example, a motor, motor controller, and user control (e.g., push button) can be housed in the display case enclosure in which the door is installed.

In various implementations described herein, a door opening mechanism is provided in a display case that includes a torque rod coupled between a door for the display case and an enclosure. In some implementations, however, a display case may not include a torque rod.

In various implementations described herein, the motorized door opening mechanism the display case door is hinged with respect to a refrigerated enclosure. In other implementations, a motorized door opening or closing mechanism opens or closes a sliding door of a refrigerated enclosure. Control of the door opening mechanism can be performed in a similar manner to that described above. For example, a motor controller can operate a motor or linear actuator in response to trigger conditions, a user action, or sensor input.

In various implementations described herein, a door opening mechanism opens or closes a door of a display case. Door opening and closing mechanisms as described herein can, in other implementations, be used in doors for other types of enclosures and systems.

While a number of examples have been described for illustration purposes, the foregoing description is not intended to limit the scope of the invention, which is defined by the scope of the appended claims. There are and will be other examples and modifications within the scope of the following claims. Furthermore, one of skill in the art would appreciate that features described in reference to a specific embodiment are not limited to that embodiment and can be interchanged with features of other embodiments.

What is claimed is:

1. A display case door, comprising:
a door frame extending about and coupled to a panel assembly;
a motor coupled to the door frame; and
a torque rod coupled to the door frame and configured to couple with an enclosure for a display case,
wherein, when the door is installed in an opening of the enclosure for the display case:
the motor is operable to open the display case door, and
the torque rod is configured to close the display case door.

2. The display case door of claim 1, further comprising a hinge, wherein the motor is coupled to the hinge.

3. The display case door of claim 1, wherein the motor is coupled to a portion of the torque rod.

4. The display case door of claim 3, wherein the motor is configured to rotate a portion of the door frame relative to the portion of the torque rod such that the door swings out.

5. The display case door of claim 1, wherein:
the motor is configured to couple between the enclosure and the door frame, and
when the motor is coupled between enclosure and the door frame, the motor is operable to open the display case door.

6. The display case door of claim 1, wherein the motor is configured to couple between the enclosure and a portion of the torque rod.

7. The display case door of claim 1, wherein the motor is configured to rotate a first portion of the torque rod relative to a second portion of the torque rod.

8. The display case door of claim 1, further comprising a motor controller configured to control the motor to swing the display case door such that the display case door opens.

9. The display case door of claim 1, wherein the motor is operable to close the display case door.

10. The display case door of claim 1, wherein:
the display case door comprises a motor controller, and
the motor controller is configured to control the motor to swing the display case door such that the display case door shuts.

11. The display case door of claim 1, further comprising a hold open device comprising a detent, wherein:
the hold open device is configured to hold the display case door open at a pre-determined angle, and
the motor is operable to overcome a force of the detent such that the torque rod closes the display case door.

12. The display case door of claim 1, further comprising:
a motor controller configured to open the door in response to a command from a user; and
a user control coupled to the motor controller.

13. The display case door of claim 1, further comprising a motor controller configured to:
determine whether a condition for opening the door has been met; and
control the motor to open the display case door based on determining that the condition has been met.

14. The display case door of claim 1, further comprising a motor controller configured to, in response to receive a signal, determine whether a trigger condition for opening the door has been met.

15. The display case door of claim 13, further comprising one or more sensors coupled to the motor controller, wherein the motor controller is configured to open the door in response to receiving a signal from at least one of one or more sensors.

16. The display case door of claim 14, wherein at least one of the one or more sensors is a motion sensor.

17. The display case door of claim 14, wherein at least one of the one or more sensors is configured to respond to a voice command.

18. The display case door of claim 14, wherein at least one of the one or more sensors is a gesture recognition sensor.

19. The display case door of claim 14, wherein at least one of the one or more sensors is a presence sensor.

20. The display case door of claim 13, further comprising one or more sensors coupled to the motor controller, wherein the motor controller is configured to close the display case door in response to receiving a signal from the sensor.

21. The display case door of claim 20, wherein at least one of the one or more sensors is a temperature sensor.

22. The display case door of claim 13, further comprising one or more sensors coupled to the motor controller, wherein the motor controller is configured to stop closing the display case door in response to receiving a signal from the sensor.

23. The display case door of claim 13, further comprising a sensor configured to detect whether there is an obstruction to closing the door, wherein the motor controller is configured to inhibit operation of the motor in response to receiving a signal from the sensor.

24. A display case door, comprising:
an insulated panel assembly comprising one or more panes;
a door frame extending about and coupled to the insulated panel assembly, the door frame comprising a hinge-side rail; and
a motor assembly coupled to the hinge-side rail, wherein the motor assembly comprises a motor and one or more drive members,
wherein, when the door installed is in an opening of an enclosure for a display case, the motor is operable to open the display case door.

25. The display case door of claim 24, wherein at least one of the one or more drive members is at least partially enclosed in the hinge-side rail.

26. A system for opening a display case door, comprising:
a door opening mechanism configured to be coupled to a hinge-side frame of a display case door and exert an opening force against a hinge device of the display case door, the door opening mechanism comprising:
a motor coupled to an output gear, wherein the output gear is arranged to engage with corresponding portion of the door hinge device; and
a motor controller electrically coupled to the motor; and
wherein the motor controller is operable to control the motor to open the display case door.

27. The system for opening a display case door of claim 26, wherein the hinge device comprises a torque rod.

28. The system for opening a display case door of claim 26, wherein the hinge device includes a torque adjustment mechanism.
